(19) United States
(12) Patent Application Publication
(10) Pub. No.: US 2014/0241204 A1
(43) Pub. Date: Aug. 28, 2014

(54) TRANSIT SERVICES IN ETHERNET RINGS WITH PROTECTION

(71) Applicants: Devanand Palanisamy, Banglaore (IN); Chuong Ngo, Ontario (CA)

(72) Inventors: Devanand Palanisamy, Banglaore (IN); Chuong Ngo, Ontario (CA)

(73) Assignees: Alcatel-Lucent India Limited, Gurgaon (IN); Alcatel-Lucent Canada Inc., Ottawa (CA)

(21) Appl. No.: 13/775,361

(22) Filed: Feb. 25, 2013

(51) Int. Cl. H04L 12/24

(52) U.S. Cl. CPC H04L 41/12
USPC 370/254

(57) ABSTRACT

Various exemplary embodiments relate to a method for transmitting data packets in a cellular network to a user equipment using a first distributed access gateway, including: receiving a first tunnel request from a second distributed access gateway; establishing a first tunnel with the second distributed access gateway; receiving a first data packet destined to the user equipment from a native packet transport network; and transmitting the first data packet to the user equipment via the first tunnel to the second distributed access gateway.

### TECHNICAL FIELD

Various exemplary embodiments disclosed herein relate generally to transit services in Ethernet rings.

### BACKGROUND

Today's communication networks, for example, the Internet, local area networks (LAN), wide area networks (WAN), etc., are often implemented using Ethernet rings. Ethernet rings may include many nodes. These Ethernet rings include communication in both directions along the ring in order to provide redundant communication between any two nodes. In order to prevent looping problems in the Ethernet ring, ring protection switching may be used, where one of the links between to nodes of the ring is designated as a ring protection link (RPL). The RPL typically is not used during normal operation, but only becomes active when there is a problem in a link elsewhere in the ring.

In an Ethernet ring protected by G.8032/ERPS (Ethernet Ring Protection Switching), for each provisioned L2 Data service, the operator has to configure, on each ring node, a L2 virtual switch instance (VSI) and two L2 interfaces. A VSI is a L2 virtual switch configured in a network element (NE). Network elements may include any switches or routers which offer layer 2 virtual private LAN services (VPLS). Each of the virtual switches in a NE may belong to a different L2 VLAN, in other words, belong to different data services. Those L2 interfaces are on the two ring ports. This is irrespective of the fact whether customer premises equipment (CPE) is connected to the ring node or not. This shall lead to consumption of more network resources on each ring node and processing power. Further, this may also lead to an increased possibility of making errors during service provisioning.

For example, consider a G.8032 ring of 20 NEs that has a customer who has CPE connected only to 4 NEs (also known as service sites or VSIs) out of 20, and the customer wants to have a L2 Data VPLS connecting all 4 NEs. To achieve this it is necessary to create a customer VLAN specific service access point (SAP) in all 20 network elements. Service access points are where the customer data traffic passes through a NE. The SAPs are needed in order to carry customer data through the NEs of the transport network that carries the traffic. This means that each of the 16 NEs without CPE should have 2 SAPs, one for each direction of the ring. Hence an additional 32 SAPs are needed to implement the service, irrespective of whether the customer data traffic terminates on the NE or not, and this means that the network resources are not efficiently or optimally used.

One solution to reduce the number of customer specific L2 Interfaces needed to provide data traffic continuity for the customer service on the Ethernet ring is to use a pass-through L2 cross-connection (a virtual switch service (VSI) with two L2 interfaces with *.*/Q.* encapsulation) feature which helps reduce the configuration of L2 interfaces on ring NEs.

In current solutions, the pass-through L2 cross-connections may be shared between all data services created on the Ethernet ring. This logically means the pass-through L2 cross-connections are shared by all other customers.

A network management system (NMS) needs to maintain an up to date topology for every data service and also needs to track the pass-through L2 cross-connections individually, which is not efficient. The fact that data service instances are no longer instantiated in every ring node prohibits the construction of an end to end fully connected topology. Also insertion and removal of new network elements to the Ethernet ring with pass-through L2 cross-connection may introduce the challenge of identifying the right L2 Data VLAN service and customer etc.

The use of pass-through cross-connections may make the management of VLANs using the ring a very difficult task. It helps maximize efficient use of the Ethernet ring resources but complicates the operations, administration, and management (OA&M) functionality. Currently no management construct exists today that tracks and manages the pass-through L2 cross-connections. Also, this practice makes the management of data services (VLANs) using the ring a very difficult task. There is no special management construct exist today that tracks & manages the pass-through L2 cross-connections. Because L2 interfaces are no longer consecutive, building a per-service topology, finding the actual status of the data path between the virtual switches is currently not possible and requires a solution.

### SUMMARY

A brief summary of various exemplary embodiments is presented below. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of configuring a transit service on an Ethernet ring by a network management system, including: configuring, by the network management system, an Ethernet ring network including configuring a transit service; receiving, by the network management system, a request for a virtual local area network (VLAN); configuring the VLAN on the Ethernet ring; receiving status data relating to the Ethernet ring; and correlating the received status data with a VLAN status data.

Various exemplary embodiments relate to a network management system that establishes a transit service on an Ethernet ring, the network management system including: a data storage; a processor in communication with the data storage, the processor being configured to: configure an Ethernet ring network including configuring a transit service; receive a request for a virtual local area network (VLAN); configure the VLAN on the Ethernet ring; receive status data relating to the Ethernet ring; and correlate the received status data with a VLAN status data.

Various exemplary embodiments relate to a non-transitory machine-readable storage medium encoded with instructions for execution by an network management system for configuring a transit service on an Ethernet ring, the medium including: instructions for configuring, by the network management system, an Ethernet ring network including configuring a transit service; instructions for receiving, by the network management system, a request for a virtual local area network (VLAN); instructions for configuring the VLAN on the Ethernet ring; instructions for receiving status data relating to the Ethernet ring; and instructions for correlating the received status data with a VLAN status data.

### BRIEF DESCRIPTION OF THE DRAWINGS

In order to better understand various exemplary embodiments, reference is made to the accompanying drawings, wherein:

FIG. 1 illustrates a typical G.8032 protected Ethernet ring;

FIG. 2 illustrates the logical topology of the Ethernet ring with a single instance of ring protection;

FIG. 3 illustrates implementing a VPLS service topology on a protected Ethernet ring according to the prior art;

FIG. 4 illustrates the implementation of a transit service on an Ethernet ring with protection and a data service using in the transit service;

FIG. 5 illustrates an Ethernet ring that implements two different VLANs using the transit service;

FIG. 6 illustrates two Ethernet rings implementing two instances of the transit service;

FIG. 7 illustrates a network management system implementing a transit service on an Ethernet ring; and

FIG. 8 illustrates a method of implementing a transit service by a network management system.

To facilitate understanding, identical reference numerals have been used to designate elements having substantially the same or similar structure or substantially the same or similar function.

### DETAILED DESCRIPTION

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or (i.e., and/or), unless otherwise indicated (e.g., “or else” or “or in the alternative”). Also, the various embodiments described herein are not necessarily mutually exclusive, as some embodiments may be combined with one or more other embodiments to form new embodiments.

Referring now to the drawings, in which like numerals refer to like components or steps, there are disclosed broad aspects of various exemplary embodiments.

Because of the problems described above, there remains a need for a transit service that provides pass-through cross-connections while being able to manage the VLANs using the pass-through cross-connections.

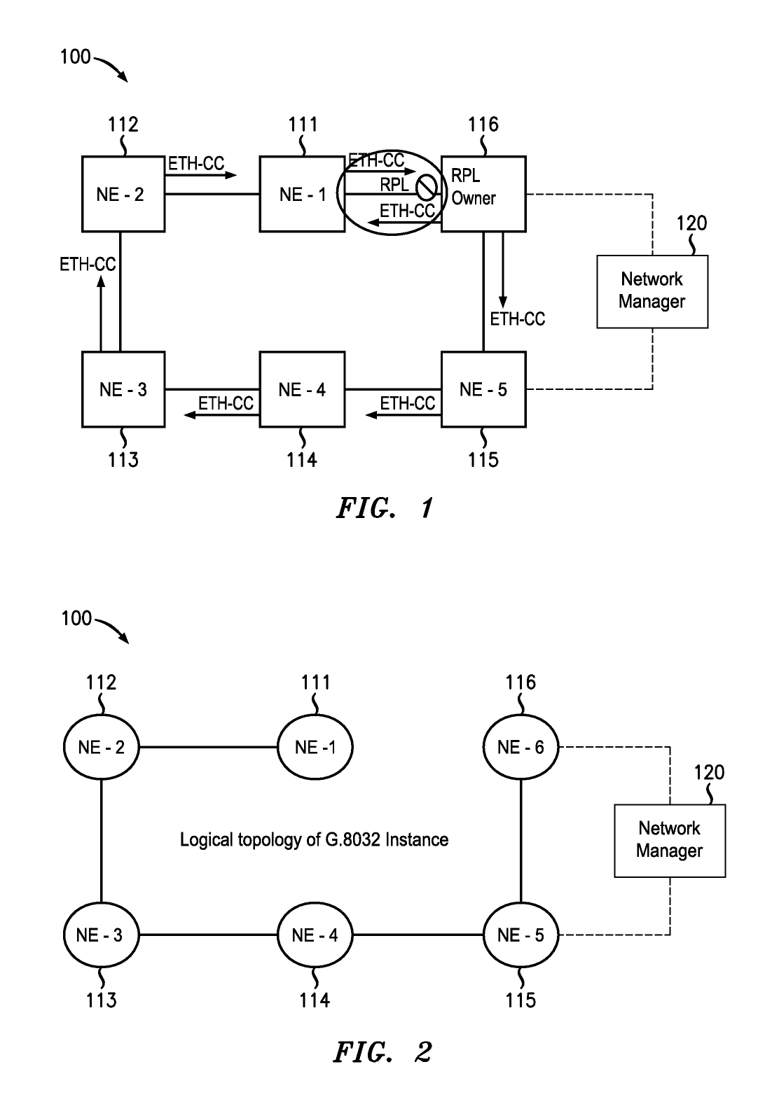

FIG. 1 illustrates a typical G.8032 protected Ethernet ring. The Ethernet ring 100 includes 6 NEs 111, 112, 113, 114, 115, 116. The NEs are arranged in a ring where each NE is connected to two adjacent NEs. In this Ethernet ring 100, there is a ring protection link (RPL) between NEs 111 and 116. During normal operation the RPL is not active in order to prevent looping problems in the Ethernet ring 100. When another link in the Ethernet ring 100 fails, the RPL becomes active to restore connectivity among all of the NEs of the Ethernet ring 100.

FIG. 2 illustrates the logical topology of the Ethernet ring with a single instance of ring protection. The network manager system (NMS) 120 may configure the Ethernet ring 100 on the NEs 111-116. Once the Ethernet ring is configured in all NEs, the RPL owner and neighbor (NEs 111 and 116) would block the link between them in order to avoid loop problems. In the case of any other link failure in the Ethernet ring 100, the blocked link between NE 111 and NE 116 will be released for customer traffic in order to restore communication between all of the NEs 111-116.

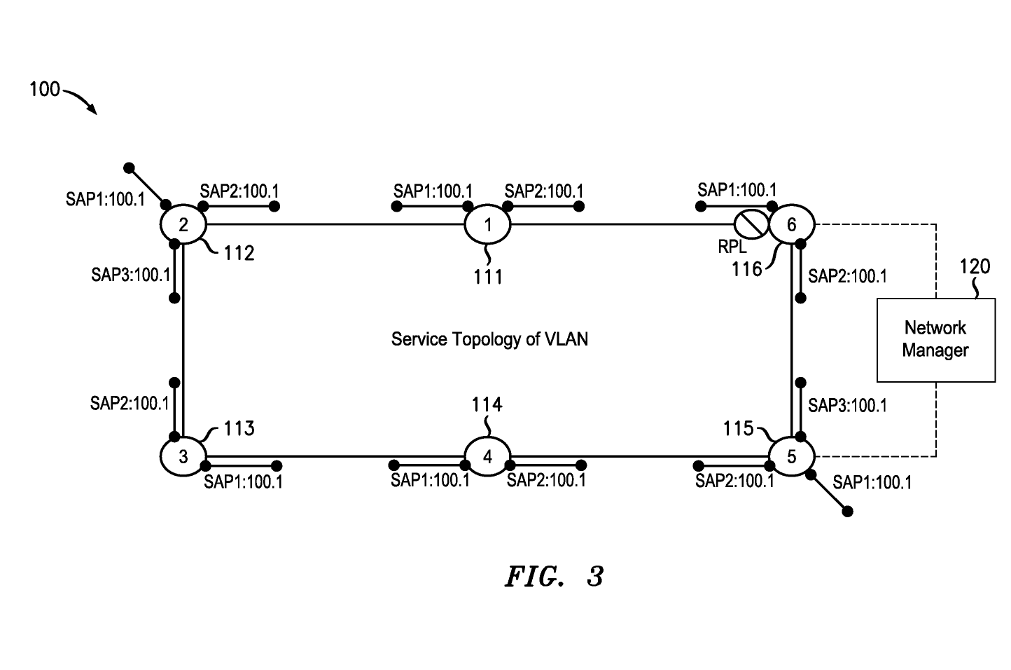

FIG. 3 illustrates implementing a VPLS service topology on a protected Ethernet ring according to the prior art. As shown in FIGS. 1 and 2 above, the Ethernet ring 100 includes NEs 111-116 and a NMS 120. A RPL is present between NE 111 and NE 116. A customer VLAN 100.1 may be configured on the Ethernet ring between NE 112 and NE 115. This may result in the customer having L2 connectivity between NE 112 and NE 115 where customer traffic from CPE enters/exits through SAPs on NE 112 and NE 115 of the VPLS service over Ethernet Ring with ring protection. In this example, customer traffic may enter and exit only on two nodes NE 112 and NE 115 of the Ethernet ring 100.

To achieve this service per the prior art solution, a customer needs to configure 3 SAPs on NE 112 and NE 115, one for customer CPE and two SAPs in each direction and needs to configure 2 SAPs on all other NEs 111, 113, 114, 116 on the Ethernet ring 100 as shown in the service topology of FIG. 3. Accordingly, 14 SAPs are needed for this two site VPLS, and for an Ethernet ring with additional NEs, two additional SAPs would be needed for each additional NE to transport the traffic in both the directions.

Accordingly, the pass-through connections created on NEs 111-116 are intended to be used for all customers' data service. The transit service typically belongs to the operator and not to any customer.

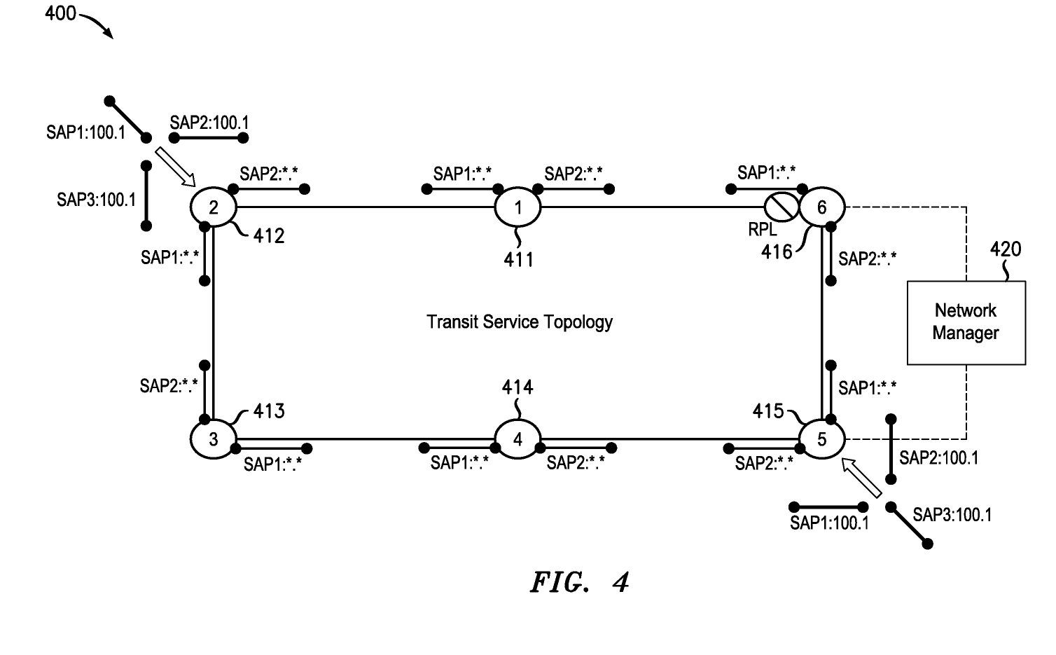

FIG. 4 illustrates the implementation of a transit service on an Ethernet ring with protection and a data service using in the transit service. The Ethernet ring 400 may include NEs 411, 412, 413, 414, 415, 416 connected in an Ethernet ring. An RPL may be implemented between NE 411 and NE 416 in order to prevent loop problems. A network management system 420 may configure the Ethernet ring 400 on the NEs 411-416. During the initial configuration, the NMS will establish pass-through L2 cross-connection/L2 access interface using *.*/Q.* Ethernet encapsulation on each NE 411-416. These transit SAPs may transport all data traffic irrespective of the customer VLAN. This means transit SAPs on each side of the ring port shall transit all customer traffic from any number of services up to the capacity of the port.

After the transit SAPs have been implemented, a customer may now implement a VPLS service on the Ethernet ring 400. The customer may have CPE installed at NE 412 and NE 415 where traffic may enter and exit the Ethernet ring 400. The NMS 420 would then install VLAN specific SAPs 100.1 on NE 412 and NE 415. Three SAPs each would be installed on NE 412 and NE 415, with one of the SAPs terminating traffic that is destined to leave the Ethernet ring and two SAPs to communicate in either direction from the NEs. Customer traffic for this VLAN would travel though NEs 411, 413, 414, and 416 using the transit SAPs installed on those NEs.

Accordingly, the transit service may be a network management concept that takes advantage of the *.*/Q.* SAP capability already available in a number of commercially available NEs. The transit service may include the collection of all pass-through L2 cross-connection defined in each and every Ethernet ring NE. This transit service may result in the better optimization of the number of data services' SAPs required and the complexity of provisioning all nodes of the Ethernet ring.

Each Ethernet ring with ring protection may be created with a transit service having pass-through L2 cross-connections with *.*/Q.* encapsulations in all Ethernet ring NE ports.

With the transit service the NMS may not create customer data L2 access interfaces on ring ports of ring nodes without connection to the CPE's for each customer. Accordingly, the transit service may act as a transport tunnel for the entire Ethernet ring, and hence any L2 data VLAN services shall leverage this transport tunnel in the following ways.

The transit services may assist the NMS in creating logical connections (VLAN Links) between any two or more VSIs (Virtual Switch Instances) attached to the Ethernet Ring part of a single VLAN Service. By having these VLAN Links the NMS may provide much better OA&M solutions for the data services using the Ethernet ring, including for example the following: end to end view of the L2 Data VLAN service with proper logical connections; efficient impact analysis in terms of detecting and managing failures through the underlying transit service; alarm correlation based on transit service between ring segment/port that is just transiting the data traffic and the data services.

Further, the transit service may assist the NMS so that it shall optimize the resource and processing power by provisioning only three SAPs per node where customer traffic terminates because the NMS manages the transit service, hence the NMS may track, identify, and automatically provision the customer SAPs only on the VSIs where it is mandatory, i.e., where customer traffic terminates.

The transit service may also reduce provisioning errors, because the number of SAPs to provision may be greatly reduced. Similarly management of removing/adding a NE from/to the ring may be efficiently managed with the help of transit service where the NMS may self-adjust the relationship between the VLAN links and the affected segment.

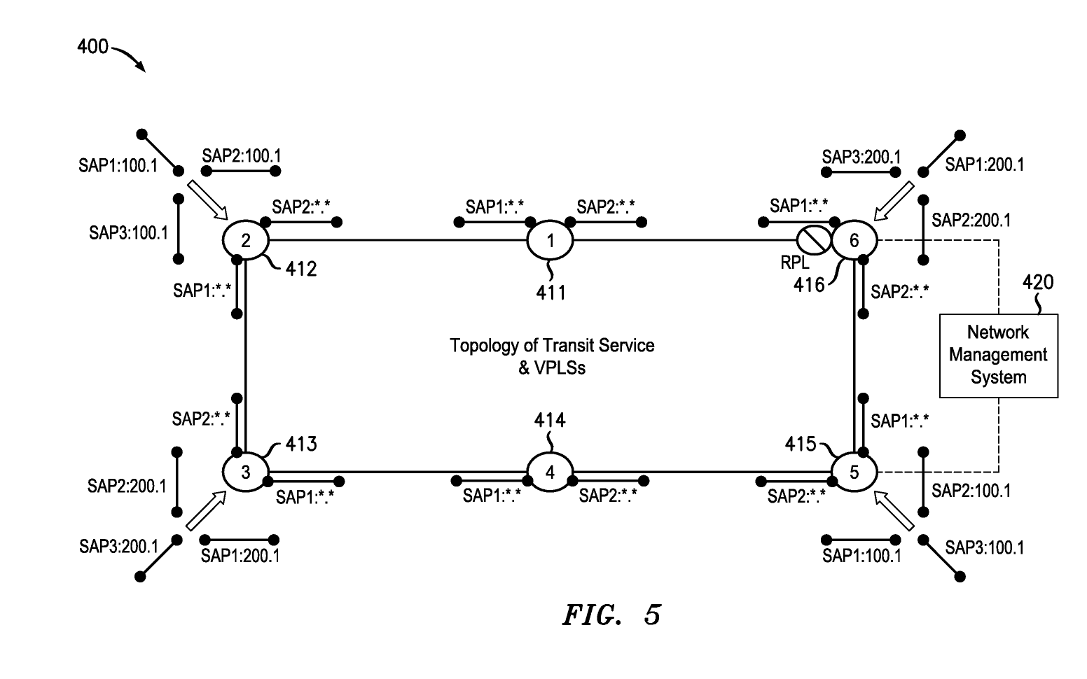

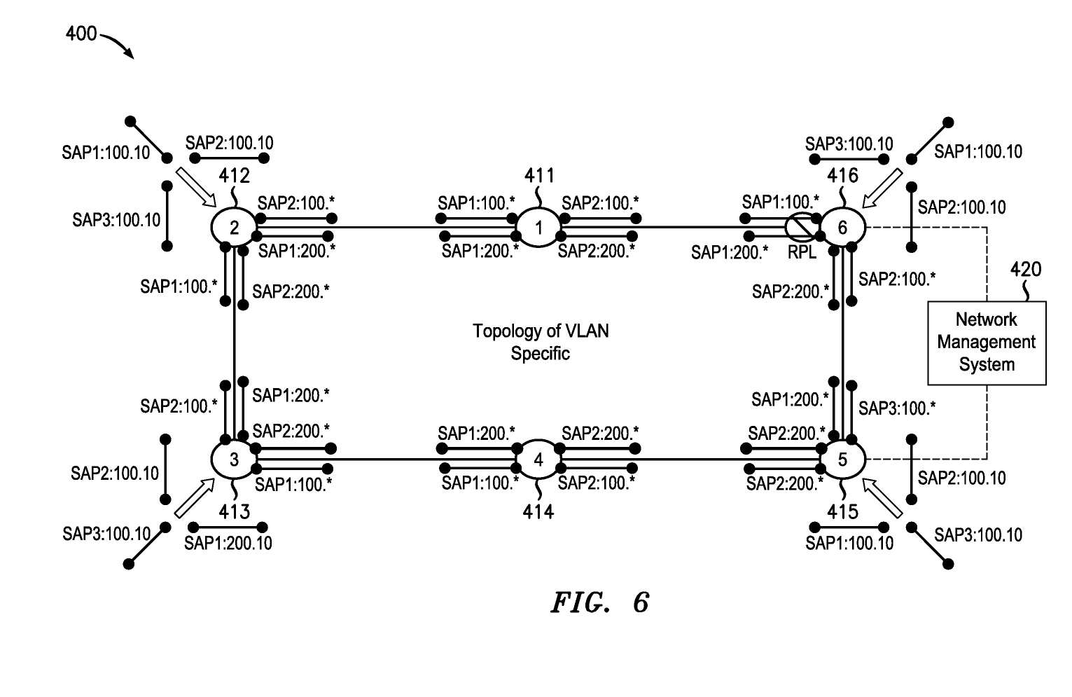

FIG. 5 illustrates an Ethernet ring that implements two different VLANs using the transit service. A first customer may implement a first VLAN 100.*, and a second customer may implement a second VLAN 200.*. The first customer may have CPE at NE 412 and NE 415 where traffic exits/enters the Ethernet ring 400. Accordingly, the first customer implements 3 SAPs 100.1 each at NE 412 and NE 415. The second customer may have CPE at NE 413 and NE 416 where traffic exits/enters the Ethernet ring 400. Accordingly, the first customer implements 3 SAPs 100.1 each at NE 412 and NE 415. Further, any number of additional customer VLANs may be implemented on the Ethernet ring 400 as well by simply adding the needed SAPs at NEs where traffic will enter/exit the Ethernet ring 400.

There may be situations where there is a need for different classes of service to be offered over the Ethernet ring 400. For example, different quality of service (QoS) may be required by different customers or for different applications. In such a situation, the NMS 420 may implement two different transit services on the Ethernet ring 400 where each transit service offers different QoS. FIG. 6 illustrates two Ethernet rings implementing two instances of the transit service. A first transit service may be implemented on a first Ethernet ring using 100.* with transit SAPs specific to the first transit service being implemented on each NE. Further, a second transit service may be implemented on a second Ethernet ring using 200.* with transit SAPs specific to the first transit service being implemented on each NE. Further additional instances of the transit service may also be implemented as needed, for example, 300.*, 400.*, etc.

More than one logical protection rings may be implemented in a physical Ethernet Ring. Transit services may still be implemented in these situations.

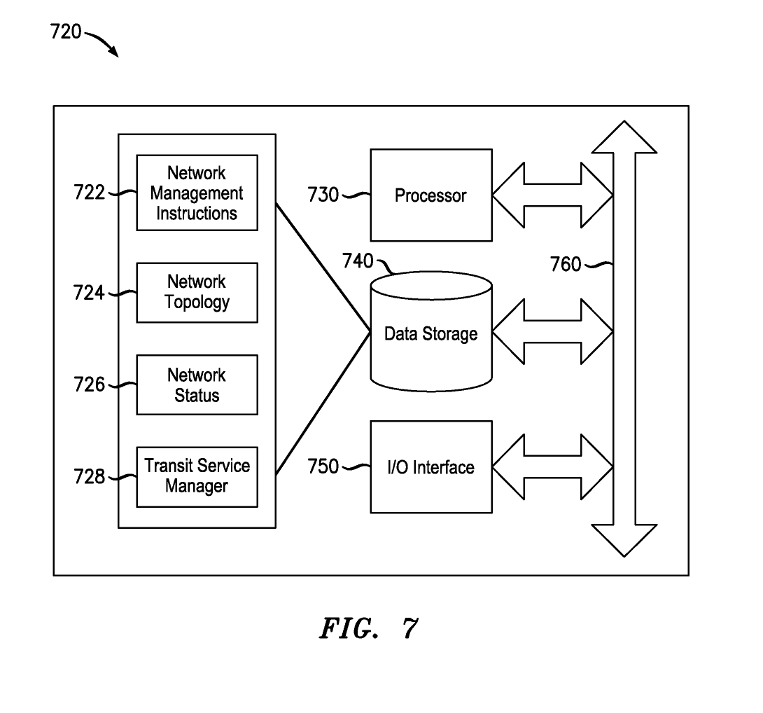

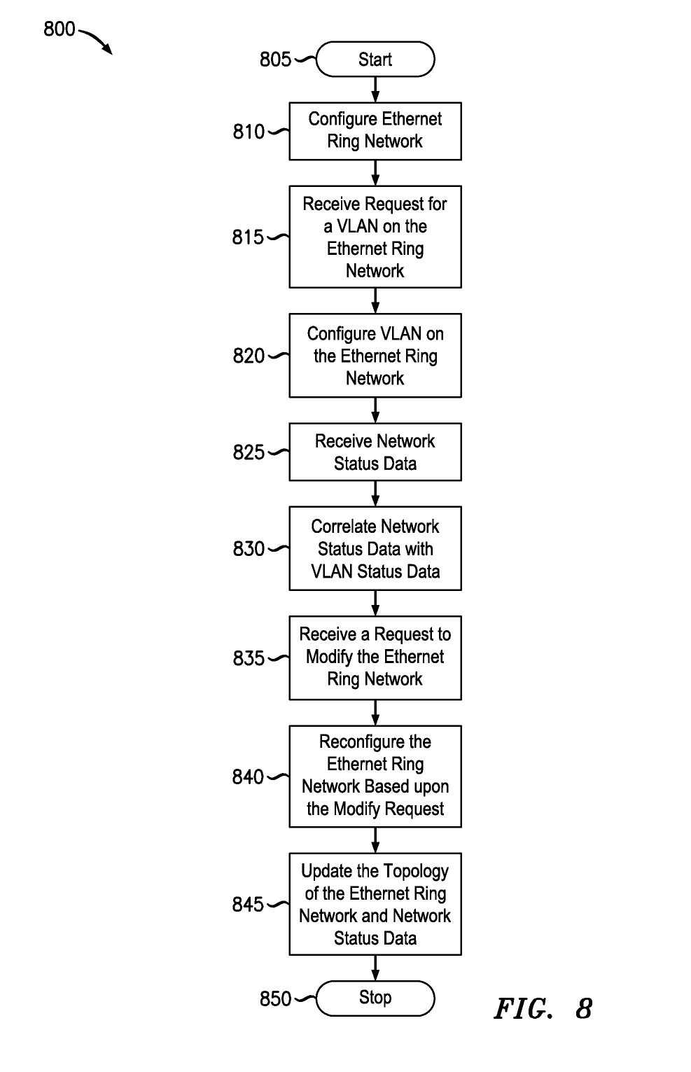

FIG. 7 illustrates a network management system implementing a transit service on an Ethernet ring. The NMS 720 may correspond to NMSs 120, 420. The NMS 720 may include a processor 730, data storage 740, and I/O interface 750, and an I/O communication channel 760.

The processor 730 may control the operation of the NMS 720 and cooperate with the data storage 740 and the I/O interface 750, via a system bus. As used herein, the term “processor” will be understood to encompass a variety of devices such as microprocessors, field-programmable gate arrays (FPGAs), application-specific integrated circuits (ASICs), and other similar processing devices.

The data storage 740 may store program data such as various programs useful in implementing the functions described above. For example, the data storage 740 may store network management instruction for performing various functions carried out by the NMS 720. The data storage 740 may also store data relating to the network topology 724. Such topology may provide information regarding the physical and logical structure of the Ethernet ring. Further, the data storage 740 may store network status that may include any typical status information maintained for the network as well as VLAN data relating to VLANs implemented using the Ethernet ring. Finally, the data storage 740 may store data related transit service manager, which may include various data specific to the transit services.

The I/O interface 750 may cooperate with the processor 730 to support communications over one or more communication channels. For example, the I/O interface 750 may include a user interface, such as a keyboard and monitor, and/or a network interface, such as one or more Ethernet ports. The I/O communication channel 760 may include various types of communication protocols and physical layers in order to manage the network.

In some embodiments, the processor 730 may include resources such as processors/CPU cores, the I/O interface 750 may include any suitable network interfaces, or the data storage 740 may include memory or storage devices such as magnetic storage, flash memory, random access memory, read only memory, or any other suitable memory or storage device. Moreover the NMS 720 may be any suitable physical hardware configuration such as: one or more server(s), blades consisting of components such as processor, memory, network interfaces or storage devices.

FIG. 8 illustrates a method of implementing a transit service by a network management system. The method 800 may begin at 805. The NMS may first configure an Ethernet ring network 810. Configuring the Ethernet ring network includes establishing a transit service that may include establishing a transit SAP at each NE in the Ethernet ring. Further, if multiple transit services are to be established, they may also be established at this time.

At step 815, the NMS may receive a request to establish a VLAN on the Ethernet ring network. Next, the NMS may configure the VLAN on the Ethernet ring network at step 820. This may include establishing three SAPs at each NE where data enters/exits the Ethernet ring. At this time multiple requests to establish multiple VLANs may be received leading to multiple VLANs being established on the Ethernet ring.

At step 825, the NMS may receive status data regarding the status of the Ethernet ring network. Such status data may include any change to network topology. For example, failures of links or the degradation of links may be reported. Also, the use of the protection link to compensate for another link failure may be reported.

At step 830, the status data received may be correlated with VLAN status data. For example, if a link between to NEs without a customer SAP but passing customer traffic through pass-through cross-connection bound to transit service fails or degrades, such information may be correlated to a customer VLAN service using the failed or degraded link, and the status of the VLAN service updated to indicate the problem.

The NMS may receive a request to modify the Ethernet ring network at step 835. Such a request may, for example, include adding or removing a NE to the Ethernet ring. At step 840, the NMS may implement the modification, for example adding or removing the designated NE to/from the Ethernet ring based upon the modify request. Then the NMS may update the topology of the Ethernet ring network, create the transit service in pass-through cross-connection on the ring ports of the newly added NE in case a NE has been added to the Ethernet ring and update the topology of all VLANs at step 845. Finally, the method 800 may end at step 850.

Embodiments of the transit service as discussed above may solve the following technical problems. The transit service may provide an end to end view of the data service which is not continuous by using the transit service as transport tunnel. The transit service will provide information regarding the state of the VLAN links based on the state of the transit service in the segment between the two ring nodes where the data service instances are defined. Further, the transit service allows for efficient impact analysis and alarm correlation between ring segments that are not directly connected to the Ethernet ring NEs providing customer specific data service instances. Further, the transit services enhance the efficient, error free provisioning and management of data services and network resources. Once the transit service is created, the NMS may make sure further L2 data services make use of the transit service as a transport tunnel thereby assuring that only the minimum and necessary network resources are created for the data traffic to reach the desired destinations in the Ethernet ring, hence network resources usage and processing power may be optimized.

Once the transit service is provisioned on all NEs of the Ethernet ring, for any new L2 VLAN service, the NMS may create customer L2 access interfaces only where CPE is connected to the Ethernet ring. Because the transit service is not attached to a specific customer, any change or removal in the customer L2 data VLAN service/VPLS shall not impact the other customers. Further, billing for each customer may be handled independently of any other customers using the Ethernet ring. Finally, the transit service may provide an efficient way of managing all pass-through L2 cross-connections/L2 access interfaces in a single service in an efficient manner as a common entity shared by all, and any change in the network, addition/removal of NEs to the Ethernet Ring may be managed easily.

In the description above of various embodiments, it is noted that various method steps are described. Such steps are described in a certain order. It is not intended that such an order is the only order possible. Therefore, other embodiments where the steps are performed in different orders are considered to be within the scope of the claims. Further, the use of the descriptors first, second, third, etc. are not intended to require that certain steps be carried out in a specific order, rather these terms are used to differentiate multiple instances of various distinct and separate elements of the same type that my appear repeatedly in the embodiments.

When processor-executable programs are implemented on a processor, the program code segments may combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

It should be apparent from the foregoing description that various exemplary embodiments of the invention may be implemented in hardware or firmware, such as for example, the distributed access gateway. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a tangible and non-transitory machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be effected while remaining within the spirit and scope of the invention. Accordingly, the foregoing disclosure, description, and figures are for illustrative purposes only and do not in any way limit the invention, which is defined only by the claims.

What is claimed is:

1. A method of configuring a transit service on an Ethernet ring by a network management system, comprising:
configuring, by the network management system, an Ethernet ring network including configuring a transit service;
receiving, by the network management system, a request for a virtual local area network (VLAN);
configuring the VLAN on the Ethernet ring;
receiving status data relating to the Ethernet ring; and
correlating the received status data with a VLAN status data.

2. The method of claim 1, wherein configuring a transit service includes configuring transit service access points (SAPs) on each network element in the Ethernet ring.

3. The method of claim 1, wherein configuring a transit service includes configuring a first plurality of transit service service access points (SAPs) on each network element in the Ethernet ring and configuring a second plurality of transit service SAPs on each network element in the Ethernet ring.

4. The method of claim 3, wherein the first plurality of transit service SAPs is associated with a first quality of service (Qos) and the second plurality of transit service SAPs is associated with a second Qos.

5. The method of claim 1, wherein configuring the VLAN includes installing thee service access points (SAPs) on at least one network element of the Ethernet ring where VLAN traffic exits/enters the Ethernet ring.

6. The method of claim 1, wherein receiving status data relating to the Ethernet ring including an indication that a link in the Ethernet ring has failed and wherein correlating the received status data with a VLAN status data including correlating the failed link in the Ethernet ring with link in the VLAN using the failed link.

7. The method of claim 1, further comprising:
receiving a request to reconfigure the Ethernet ring based upon a modify request;
reconfiguring the Ethernet ring based upon the modify request;
reconfiguring the transit service based upon the modify request; and
updating the topology of the Ethernet ring and the VLAN implemented on the Ethernet ring.

8. A network management system that establishes a transit service on an Ethernet ring, the network management system comprising:
a data storage;
a processor in communication with the data storage, the processor being configured to:
configure an Ethernet ring network including configuring a transit service;
receive a request for a virtual local area network (VLAN);
configure the VLAN on the Ethernet ring;
receive status data relating to the Ethernet ring; and
correlate the received status data with a VLAN status data.

9. The network management system of claim 8, wherein configuring a transit service includes configuring transit service access points (SAPs) on each network element in the Ethernet ring.

10. The network management system of claim 8, wherein configuring a transit service includes configuring a first plurality of transit service service access points (SAPs) on each network element in the Ethernet ring and configuring a second plurality of transit service SAPs on each network element in the Ethernet ring.

11. The network management system of claim 10, wherein the first plurality of transit service SAPs is associated with a first quality of service (Qos) and the second plurality of transit service SAPs is associated with a second Qos.

12. The network management system of claim 8, wherein configuring the VLAN includes installing thee service access points (SAPs) on at least one network element of the Ethernet ring where VLAN traffic exits/enters the Ethernet ring.

13. The network management system of claim 8, wherein receiving status data relating to the Ethernet ring including an indication that a link in the Ethernet ring has failed and wherein correlating the received status data with a VLAN status data including correlating the failed link in the Ethernet ring with link in the VLAN using the failed link.

14. The network management system of claim 8, wherein the processor is further configured to:
receive a request to reconfigure the Ethernet ring based upon a modify request;
reconfigure the Ethernet ring based upon the modify request;
reconfigure the transit service based upon the modify request; and
update the topology of the Ethernet ring and the VLAN implemented on the Ethernet ring.

15. A non-transitory machine-readable storage medium encoded with instructions for execution by an network management system for configuring a transit service on an Ethernet ring, the medium comprising:
instructions for configuring, by the network management system, an Ethernet ring network including configuring a transit service;
instructions for receiving, by the network management system, a request for a virtual local area network (VLAN);
instructions for configuring the VLAN on the Ethernet ring;
instructions for receiving status data relating to the Ethernet ring; and
instructions for correlating the received status data with a VLAN status data.

16. The non-transitory machine-readable storage medium of claim 15, wherein configuring a transit service includes configuring transit service access points (SAPs) on each network element in the Ethernet ring.

17. The non-transitory machine-readable storage medium of claim 15, wherein configuring a transit service includes configuring a first plurality of transit service service access points (SAPs) on each network element in the Ethernet ring and configuring a second plurality of transit service SAPs on each network element in the Ethernet ring and wherein the first plurality of transit service SAPs is associated with a first quality of service (Qos) and the second plurality of transit service SAPs is associated with a second Qos.

18. The non-transitory machine-readable storage medium of claim 15, wherein configuring the VLAN includes installing thee service access points (SAPs) on at least one network element of the Ethernet ring where VLAN traffic exits/enters the Ethernet ring.

19. The non-transitory machine-readable storage medium of claim 15, wherein receiving status data relating to the Ethernet ring including an indication that a link in the Ethernet ring has failed and wherein correlating the received status data with a VLAN status data including correlating the failed link in the Ethernet ring with link in the VLAN using the failed link.

20. The non-transitory machine-readable storage medium of claim 15, further comprising:
instructions for receiving a request to reconfigure the Ethernet ring based upon a modify request;
instructions for reconfiguring the Ethernet ring based upon the modify request;
instructions for reconfiguring the transit service based upon the modify request; and
instructions for updating the topology of the Ethernet ring and the VLAN implemented on the Ethernet ring.
